(19) United States
(12) Patent Application Publication
(10) Pub. No.: US 2024/0331927 A1
(43) Pub. Date: Oct. 3, 2024

(54) INDUCTOR AND DC-DC CONVERTER

(71) Applicant: TDK Corporation, Tokyo (JP)

(72) Inventors: Tomofumi KURODA, Tokyo (JP); Atsushi Koyama, Tokyo (JP); Seiko Komatsu, Tokyo (JP); Hajime Kuwajima, Tokyo (JP)

(73) Assignee: TDK Corporation, Tokyo (JP)

(21) Appl. No.: 18/619,729

(22) Filed: Mar. 28, 2024

(30) Foreign Application Priority Data
Mar. 30, 2023 (JP) 2023-056381

(51) Int. Cl. H01F 27/29; H01F 27/30; H01F 27/32; H02M 3/00

(52) U.S. Cl. CPC H01F 27/29; H01F 27/306; H01F 27/324; H02M 3/003

(57) ABSTRACT

The second magnetic body covers a first region surrounded by the first and second conductor portions, the first coupling portion, and a virtual line connecting the ends of the first and second conductor portions on the other side in the first direction when viewed from the third direction, the third magnetic body covers a second region surrounded by the third and fourth conductor portions, the second coupling portion, and a virtual line connecting the ends of the third and fourth conductor portions on the other side in the first direction when viewed from the third direction, a surface of the first magnetic body on the one side in the first direction is located on the other side in the first direction with respect to the first and second coupling portions, and the resin material is disposed in the first and second regions.

### CROSS REFERENCE TO RELATED APPLICATIONS

This application claims priority to Japanese Patent Application No. 2023-056381 filed on Mar. 30, 2023, the entire contents of which are incorporated by reference herein.

### TECHNICAL FIELD

The present disclosure relates to an inductor and a DC-DC converter.

### BACKGROUND

Conventionally, there is an inductor disclosed in Japanese Unexamined Patent Publication No. 2019-212806. This inductor is configured by surrounding the periphery of one gate-shaped coil conductor arranged to face another with a magnetic material, and coupling between the two coils is reduced by disposing a low-permeability portion.

### SUMMARY

According to one aspect of the present disclosure, there is provided an inductor including a first coil conductor including first and second conductor portions that extend in a first direction, and a first coupling portion that couples ends of the first and second conductor portions on one side in the first direction to each other and extends in a second direction orthogonal to the first direction; a second coil conductor including third and fourth conductor portions that extend in the first direction, and a second coupling portion that couples ends of the third and fourth conductor portions on the one side in the first direction and extends in the second direction; a first magnetic body disposed between the first coil conductor and the second coil conductor, the first coil conductor and the second coil conductor being disposed apart from each other in a third direction orthogonal to the first direction and the second direction; a second magnetic body disposed to sandwich a portion located between the first and second conductor portions with the first magnetic body in the third direction; a third magnetic body disposed to sandwich a portion located between the third and fourth conductor portions with the first magnetic body in the third direction; and a resin material covering at least surfaces of the first, second, and third magnetic bodies on the one side in the first direction, in which the second magnetic body covers a first region surrounded by the first and second conductor portions, the first coupling portion, and a virtual line connecting the ends of the first and second conductor portions on the other side in the first direction when viewed from the third direction, the third magnetic body covers a second region surrounded by the third and fourth conductor portions, the second coupling portion, and a virtual line connecting the ends of the third and fourth conductor portions on the other side in the first direction when viewed from the third direction, a surface of the first magnetic body on the one side in the first direction is located on the other side in the first direction with respect to the first and second coupling portions, and the resin material is disposed in the first and second regions.

A DC-DC converter according to one aspect of the present disclosure includes the inductor described above.

### BRIEF DESCRIPTION OF THE DRAWINGS

FIG. 1 is a perspective view of an inductor according to the present embodiment;

FIG. 2 is a development view of an inductor;

FIG. 3 is a side view of the inductor;

FIG. 4 is a sectional view taken along line IV-IV in FIG. 3;

FIG. 5 is a view of a coil conductor when viewed from an X direction;

FIG. 6 is a side view illustrating a modification example; and

FIG. 7 is a diagram illustrating a circuit of a DC-DC converter using the inductor illustrated in FIG. 1.

### DETAILED DESCRIPTION

However, when a variation in dimension of a low-permeability portion is large, there is a problem that a variation in inductance becomes large.

Therefore, an object of the present disclosure is to provide an inductor and a DC-DC converter capable of improving adhesion between a component and a resin material and reducing a variation in inductance.

According to one aspect of the present disclosure, it is possible to provide an inductor and a DC-DC converter capable of improving adhesion between a component and a resin material and reducing a variation in inductance.

Hereinafter, some embodiments of the present disclosure will be described in detail. In this regard, the present disclosure is not limited to the following embodiments.

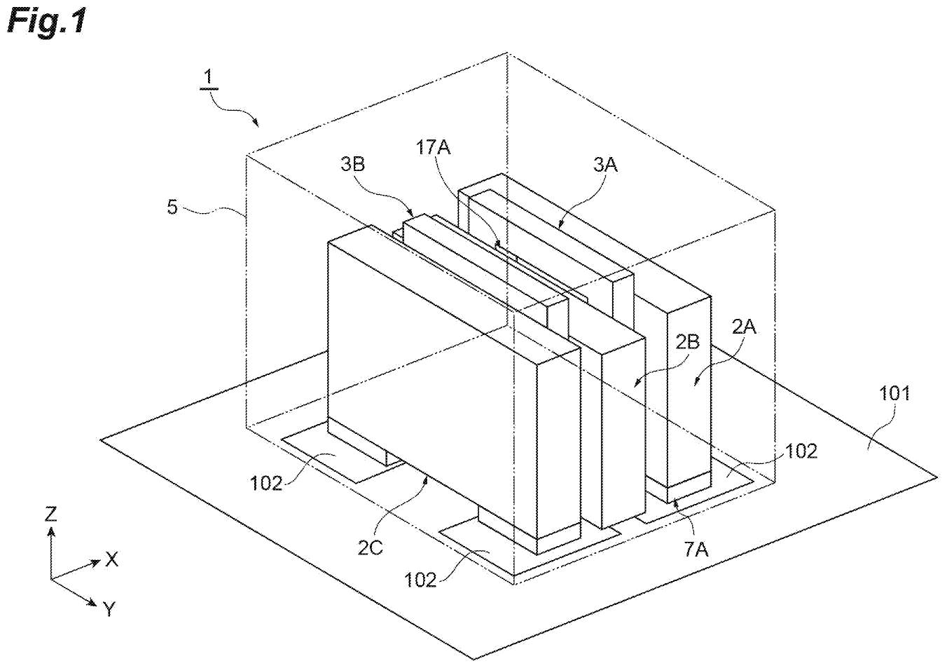

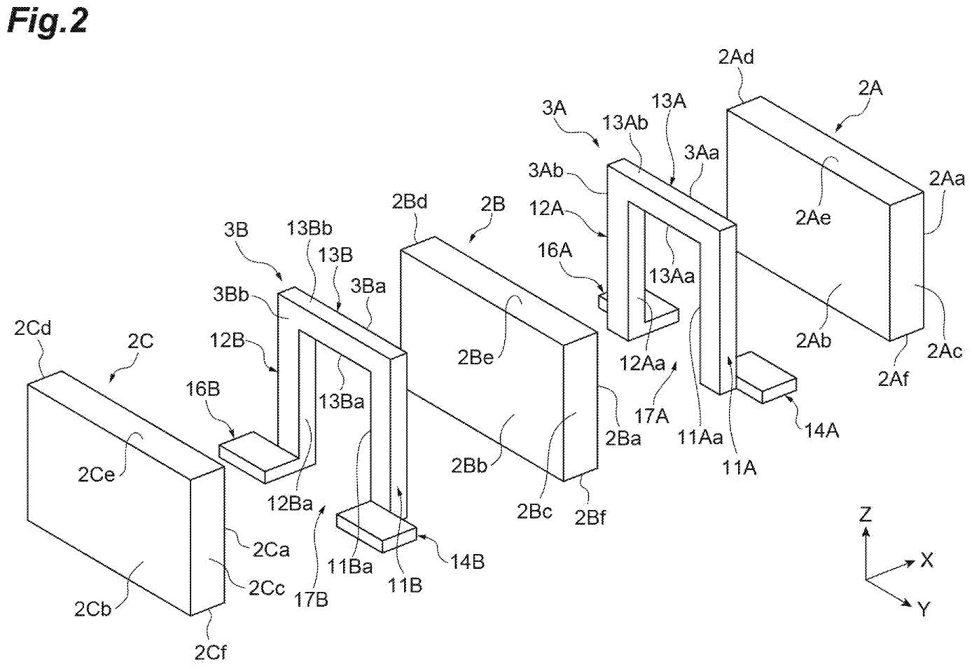

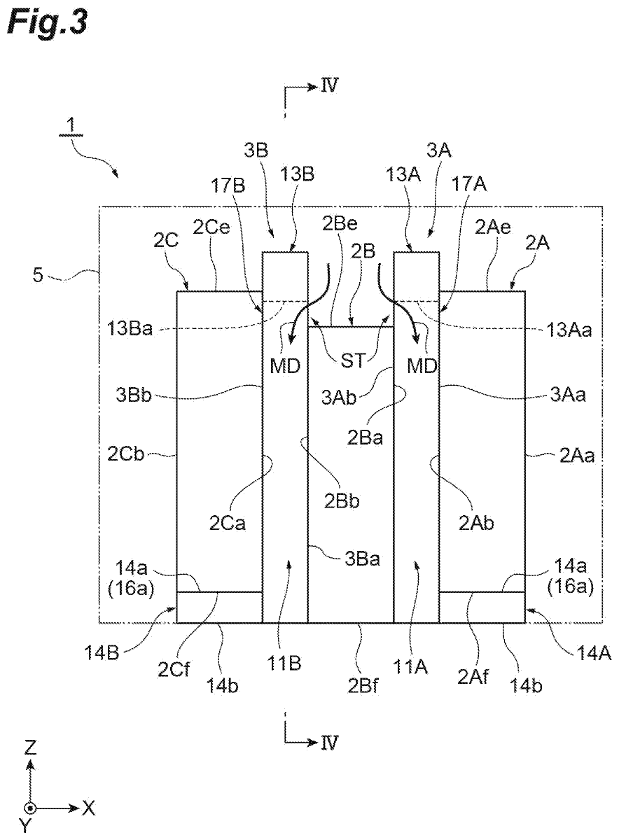

First, a schematic configuration of an inductor 1 according to the present embodiment will be described with reference to FIGS. 1, 2, and 3. FIG. 1 is a perspective view of an inductor 1 according to the present embodiment. FIG. 2 is a development view of the inductor 1. FIG. 3 is a side view of the inductor 1. FIG. 1 illustrates a state in which the inductor 1 is mounted on a substrate 101. The inductor 1 according to the present embodiment is formed by stacking magnetic bodies 2A, 2B, and 2C and coil conductors 3A and 3B in an X-axis direction. In the present embodiment, the X-axis direction, a Y-axis direction, and a Z-axis direction are orthogonal to each other. The Z-axis direction corresponds to a “first direction” in the claims, the Y-axis direction orthogonal to the Z-axis direction corresponds to a “second direction” in the claims, and the X-axis direction orthogonal to the Z-axis direction and the Y-axis direction corresponds to a “third direction” in the claims.

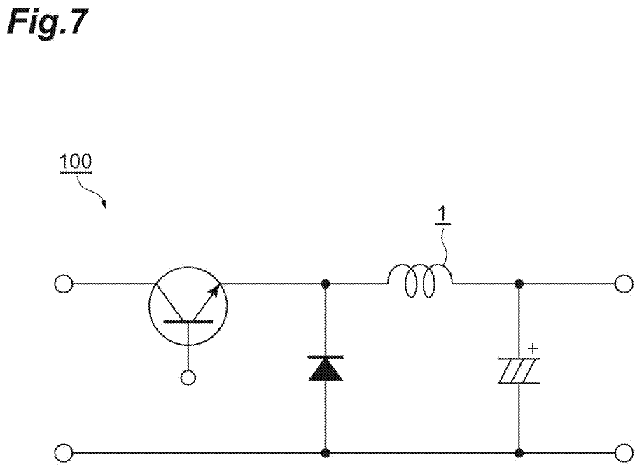

As illustrated in FIGS. 1 and 3, the inductor 1 includes the magnetic body 2A (second magnetic body), the magnetic body 2B (first magnetic body), the magnetic body 2C (third magnetic body), the coil conductor 3A (first coil conductor), the coil conductor 3B (second coil conductor), and a resin material 5. In FIGS. 1 and 3, the resin material 5 is indicated by a virtual line in order to facilitate understanding of the features. The inductor 1 may be adopted as a choke coil of a circuit of a DC-DC converter 100 illustrated in FIG. 7.

The magnetic body 2A and the magnetic body 2B are disposed to face each other while being separated from each other in the X-axis direction. The magnetic body 2B and the magnetic body 2C are arranged to face each other while being separated from each other in the X-axis direction. The magnetic bodies 2A, 2B, and 2C are arranged in order from the positive side in the X-axis direction. The magnetic bodies 2A, 2B, and 2C have rectangular parallelepiped shapes. In the present embodiment, the magnetic bodies 2A, 2B, and 2C have rectangular parallelepiped shapes that are flat in the X-axis direction. The magnetic bodies 2A, 2B, and 2C have the same shape. The magnetic bodies 2A, 2B, and 2C may be made of, for example, a sintered magnetic core such as MnZn-based ferrite or NiZn-based ferrite or a magnetic material such as a multilayer magnetic core formed by laminating soft magnetic metal plates. The magnetic permeability of the magnetic bodies 2A, 2B, and 2C may be 1000 or more. The magnetic bodies 2A, 2B, and 2C may have substantially the same or different magnetic characteristics.

The DC-DC converter 100 includes a pair of input terminals to which a DC input voltage is input, a pair of output terminals, a switching element and a choke coil connected in series to a high potential side of the pair of input terminals, a diode connected between a connection point between the switching element and the choke coil and a low potential side of the pair of input terminals, and a capacitor connected between the pair of output terminals. The DC-DC converter 100 operates as a step-down converter that steps down an input DC voltage by switching on and off of the switching element on the basis of a control signal from a control circuit (not illustrated). Note that the DC-DC converter 100 may be a multiphase converter including a plurality of conversion units each including a switching element, a choke coil, and a diode, the conversion units being connected in parallel, and the inductor 1 may be employed as the choke coil of each conversion unit.

The magnetic body 2A has principal surfaces 2Aa and 2Ab, end surfaces 2Ac and 2Ad, and side surfaces 2Ae and 2Af. The principal surfaces 2Aa and 2Ab are surfaces opposed to each other in the X-axis direction. The principal surface 2Aa is disposed on the positive side in the X-axis direction, and the principal surface 2Ab is disposed on the negative side in the X-axis direction. The end surfaces 2Ac and 2Ad are surfaces opposed to each other in the Y-axis direction. The end surface 2Ac is disposed on the positive side in the Y-axis direction, and the end surface 2Ad is disposed on the negative side in the Y-axis direction. The side surfaces 2Ae and 2Af are surfaces opposed to each other in the Z-axis direction. The side surface 2Ae is disposed on the positive side in the Z-axis direction, and the side surface 2Af is disposed on the negative side in the Z-axis direction.

The magnetic body 2B has principal surfaces 2Ba and 2Bb, end surfaces 2Bc and 2Bd, and side surfaces 2Be and 2Bf. The magnetic body 2C has principal surfaces 2Ca and 2Cb, end surfaces 2Cc and 2Cd, and side surfaces 2Ce and 2Cf. These surfaces have the same configurations as the principal surfaces 2Aa and 2Ab, the end surfaces 2Ac and 2Ad, and the side surfaces 2Ae and 2Af of the magnetic body 2A.

The principal surface 2Ab of the magnetic body 2A and the principal surface 2Ba of the magnetic body 2B are disposed to face each other in a state of being separated from each other in the X-axis direction. The principal surface 2Bb of the magnetic body 2B and the principal surface 2Ca of the magnetic body 2C are disposed to face each other in a state of being separated from each other in the X-axis direction. As a result, the magnetic body 2A is disposed to sandwich a portion (region 17A) located between conductor portions 11A and 12A that will be described later with the magnetic body 2B in the X-axis direction. The magnetic body 2C is disposed to sandwich a portion (region 17B) located between conductor portions 11B and 12B described later with the magnetic body 2B in the X-axis direction. In the present embodiment, the end surfaces 2Ac and 2Ad, the end surfaces 2Bc and 2Bd, and the end surfaces 2Cc and 2Cd are disposed at the same position in the Y-Z plane to overlap each other when viewed from the X-axis direction. Therefore, the magnetic bodies 2A, 2B, and 2C have the same area when viewed from the X-axis direction. The thicknesses of the magnetic bodies 2A, 2B, and 2C in the X-axis direction are also the same. That is, the magnetic bodies 2A, 2B, and 2C have the same size. Note that, in the present specification, “same position” includes a positional deviation within a range caused by a manufacturing error or the like, and “same” and “same size” include an error within a range caused by a manufacturing variation. Among the magnetic bodies, the magnetic body 2B is disposed at a position closer to the negative side in the Z-axis direction as a whole than the magnetic bodies 2A and 2C. Note that only the magnetic body 2B may have a smaller dimension in the X-axis direction than the magnetic bodies 2A and 2C. By thinning the magnetic body 2B, the inductor 1 can be downsized. Also in this case, the magnetic bodies 2A, 2B, and 2C have the same area when viewed from the X-axis direction.

The coil conductor 3A includes a conductor portion 11A (first conductor portion), a conductor portion 12A (second conductor portion), a coupling portion 13A (first coupling portion), a terminal portion 14A (first terminal portion), and a terminal portion 16A (second terminal portion). The material of the coil conductor 3A is made of a metal selected from, for example, Cu, Ag, Au, Al, Ni, and Sn.

The conductor portions 11A and 12A extend in the Z-axis direction and are disposed between the magnetic body 2A and the magnetic body 2B in the X-axis direction. The conductor portion 11A is disposed on the positive side in the Y-axis direction, and the conductor portion 12A is disposed on the negative side in the Y-axis direction. The coupling portion 13A is a member that couples the conductor portion 11A and the conductor portion 12A. The coupling portion 13A is connected to the ends of the conductor portions 11A and 12A on the positive side in the Z-axis direction and extends in the Y-axis direction. The terminal portion 14A is provided at the end of the conductor portion 11A on the negative side in the Z-axis direction, and extends to the positive side in the X-axis direction and the positive side in the Y-axis direction. The terminal portion 14A is configured by forming a part of the vicinity of the end of the conductor portion 11A on the negative side in the Z-axis direction to be wide toward the positive side in the Y direction and bending the wide portion toward the positive side in the X direction. The terminal portion 16A is provided at the end of the conductor portion 12A on the negative side in the Z-axis direction, and extends to the positive side in the X-axis direction and the negative side in the Y-axis direction. The terminal portion 16A is configured by forming a part of the vicinity of the end of the conductor portion 12A on the negative side in the Z-axis direction to be wide toward the negative side in the Y direction and bending the wide portion toward the positive side in the X direction. The terminal portions 14A and 16A are bonded to the electrodes 102 (see FIG. 1) of the substrate 101. As a result, the inductor 1 is mounted on the substrate 101. The conductor portions 11A and 12A need not be parallel to the Z-axis direction as long as the conductor portions 11A and 12A extend in the Z-axis direction. The coupling portion 13A needs not be parallel to the Y-axis direction as long as the coupling portion 13A extends in the Y-axis direction.

The coil conductor 3A has a side surface 3Aa on the positive side in the X-axis direction and a side surface 3Ab on the negative side in the X-axis direction. The side surface 3Aa is formed by disposing the side surfaces of the conductor portions 11A and 12A and the coupling portion 13A on the positive side in the X-axis direction on the same plane. The terminal portions 14A and 16A protrude toward the positive side in the X-axis direction from the side surface 3Aa. The side surface 3Aa faces the principal surface 2Ab of the magnetic body 2A in the X-axis direction and is in contact with each other (see FIG. 3). The side surface 3Ab is formed by disposing the side surfaces of the conductor portions 11A and 12A, the coupling portion 13A, and the terminal portions 14A and 16A on the negative side in the X-axis direction on the same plane. The side surface 3Ab faces the principal surface 2Ba of the magnetic body 2B in the X-axis direction and is in contact with each other (see FIG. 3). Since the magnetic bodies 2A, 2B, and 2C and the coil conductors 3A and 3B are disposed in contact with each other, a positional relationship among the magnetic bodies 2A, 2B, and 2C particularly in the X-axis direction is stabilized, so that a variation in inductance can be reduced. In the present specification, “contact” includes not only a case where the magnetic bodies 2A and 2B are in direct contact with the coil conductor 3A but also a case where the magnetic bodies 2A and 2B are in indirect contact with the coil conductor 3A via an insulating layer, an adhesive layer, or the like. The same applies to contact between the magnetic bodies 2B and 2C that will be described later and the coil conductor 3B.

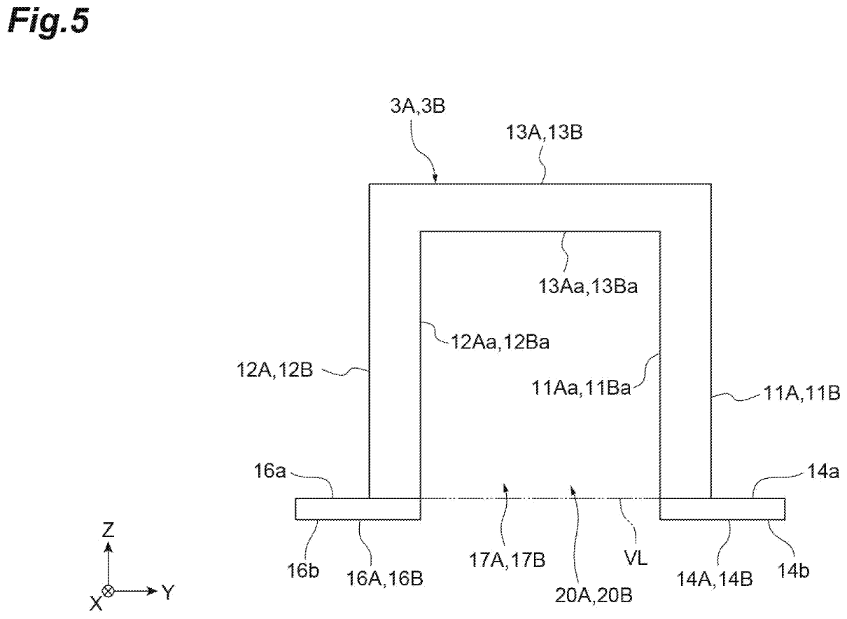

FIG. 5 is a view of the coil conductors 3A and 3B when viewed from the X-axis direction. In FIG. 5, components other than the coil conductors 3A and 3B are not illustrated. As illustrated in FIG. 5, a region 17A (first region) surrounded by the conductor portions 11A and 12A, the coupling portion 13A, and a virtual line VL connecting the ends of the conductor portions 11A and 12A on the negative side in the Z-axis direction is defined. The region 17A is formed by a region surrounded by the side surface 11Aa of the conductor portion 11A on the negative side in the Y-axis direction, the side surface 12Aa of the conductor portion 12A on the positive side in the Y-axis direction, the lower surface 13Aa of the coupling portion 13A, and the virtual line VL. The region 17A is open on the side surfaces 3Aa and 3Ab of the coil conductor 3A in the X-axis direction. The ends of the conductor portions 11A and 12A on the negative side in the Z-axis direction include not only the tips of the conductor portions 11A and 12A on the negative side in the Z-axis direction but also a portion located on the positive side in the Z-axis direction from the tips.

As illustrated in FIG. 2, the coil conductor 3B includes the conductor portion 11B (third conductor portion), the conductor portion 12B (fourth conductor portion), a coupling portion 13B (second coupling portion), a terminal portion 14B (third terminal portion), and a terminal portion 16B (fourth terminal portion). A material of the coil conductor 3B may be similar to that of the coil conductor 3A.

The conductor portions 11B and 12B extend in the Z-axis direction and are disposed between the magnetic body 2B and the magnetic body 2C in the X-axis direction. The conductor portion 11B is disposed on the positive side in the Y-axis direction, and the conductor portion 12B is disposed on the negative side in the Y-axis direction. The coupling portion 13B is a member that couples the conductor portion 11B and the conductor portion 12B. The coupling portion 13B is connected to the ends of the conductor portions 11B and 12B on the positive side in the Z-axis direction and extends in the Y-axis direction. The terminal portion 14B is provided at the end of the conductor portion 11B on the negative side in the Z-axis direction, and extends to the negative side in the X-axis direction and the positive side in the Y-axis direction. The terminal portion 14B is configured by forming a part of the vicinity of the end of the conductor portion 11B on the negative side in the Z-axis direction to be wide toward the positive side in the Y direction and bending the wide portion toward the negative side in the X direction. The terminal portion 16B is provided at the end of the conductor portion 12B on the negative side in the Z-axis direction, and extends to the negative side in the X-axis direction and the negative side in the Y-axis direction. The terminal portion 16B is configured by forming a part in the vicinity of the end of the conductor portion 12B on the negative side in the Z-axis direction to be wide toward the negative side in the Y direction and bending the wide portion toward the negative side in the X direction. The terminal portions 14B and 16B are bonded to the electrodes 102 (see FIG. 1) of the substrate 101. As a result, the inductor 1 is mounted on the substrate 101. Note that the conductor portions 11B and 12B need not be parallel to the Z-axis direction as long as the conductor portions 11B and 12B extend in the Z-axis direction. The coupling portion 13B needs not be parallel to the Y-axis direction as long as the coupling portion 13B extends in the Y-axis direction.

The coil conductor 3B has a side surface 3Ba on the positive side in the X-axis direction and a side surface 3Bb on the negative side in the X-axis direction. The side surface 3Ba is formed by disposing the side surfaces of the conductor portions 11B and 12B, the coupling portion 13B, and the terminal portions 14B and 16B on the positive side in the X-axis direction on the same plane. The side surface 3Ba faces the principal surface 2Bb of the magnetic body 2B in the X-axis direction and is in contact with the principal surface 2Bb (see FIG. 3). The side surface 3Bb is formed by arranging the side surfaces of the conductor portions 11B and 12B and the coupling portion 13B on the negative side in the X-axis direction on the same plane. The terminal portions 14B and 16B protrude toward the negative side in the X-axis direction from the side surface 3Bb. The side surface 3Bb faces the principal surface 2Ca of the magnetic body 2C in the X-axis direction and is in contact with each other (see FIG. 3).

As illustrated in FIG. 5, a region 17B (second region) surrounded by the conductor portions 11B and 12B, the coupling portion 13B, and a virtual line VL connecting the ends of the conductor portions 11B and 12B on the negative side in the Z-axis direction is defined. The region 17B is formed by a region surrounded by the side surface 11Ba of the conductor portion 11B on the negative side in the Y-axis direction, the side surface 12Ba of the conductor portion 12B on the positive side in the Y-axis direction, the lower surface 13Ba of the coupling portion 13B, and the virtual line VL. The region 17B is open on the side surfaces 3Ba and 3Bb of the coil conductor 3B in the X-axis direction. The ends of the conductor portions 11B and 12B on the negative side in the Z-axis direction include not only tips of the conductor portions 11B and 12B on the negative side in the Z-axis direction but also portions located on the positive side in the Z-axis direction from the tips.

The coil conductor 3A and the coil conductor 3B have a plane-symmetrical structure with respect to the ZY plane. Therefore, when viewed from the X-axis direction, the coil conductor 3A and the coil conductor 3B are formed in the same shape to overlap each other. Note that “plane symmetry” includes a positional deviation within a range caused by a manufacturing error or the like, and the “same shape” includes an error within a range caused by a manufacturing variation.

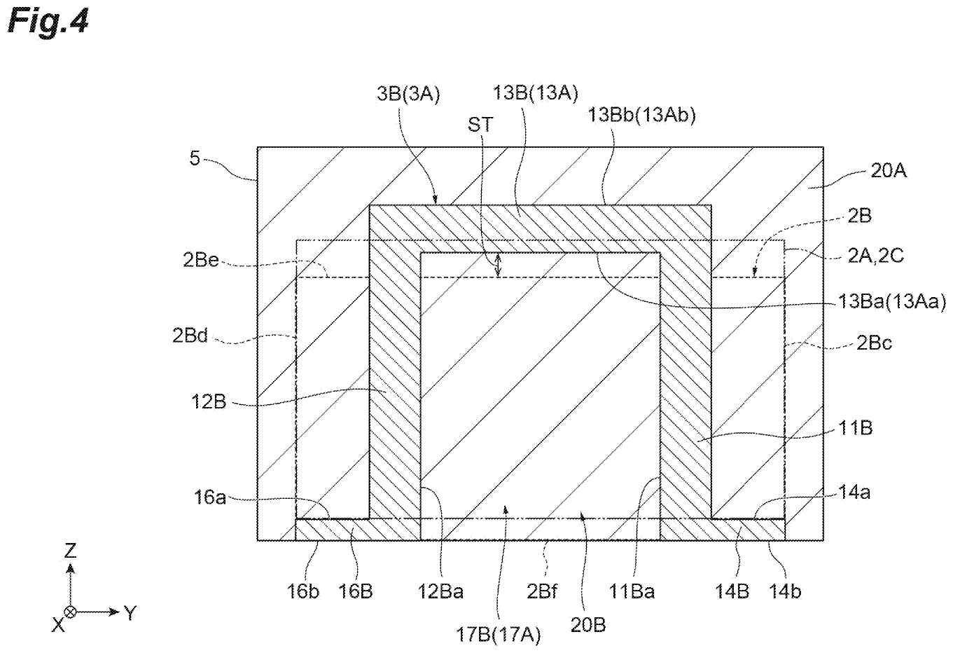

Next, a positional relationship between the magnetic bodies 2A, 2B, and 2C and the coil conductors 3A and 3B will be described in detail with reference to FIGS. 3 and 4. FIG. 4 is a cross-sectional view taken along line IV-IV illustrated in FIG. 3. In FIG. 4, the coil conductor 3B is indicated by a solid line, but the same positional relationship is established for the coil conductor 3A when viewed from the X-axis direction. In FIG. 4, the magnetic body 2B is indicated by a dashed line, and the magnetic bodies 2A and 2B are indicated by two-dot chain lines.

The magnetic body 2A covers the region 17A of the coil conductor 3A when viewed from the positive side to the negative side in the X-axis direction (see also FIG. 1). The magnetic body 2A covers the entire region 17A such that the region 17A is not exposed and a gap is not formed on the side surface 3Aa of the coil conductor 3A. The magnetic body 2C covers the region 17B of the coil conductor 3B when viewed from the negative side to the positive side in the X-axis direction (see also FIG. 1). The magnetic body 2C covers the entire region 17B such that the region 17B is not exposed and a gap is not formed on the side surface 3Bb of the coil conductor 3B. On the other hand, the magnetic body 2B covers a part of the region 17A of the coil conductor 3A when viewed from the negative side to the positive side in the X-axis direction. The magnetic body 2B covers a part of the region 17B of the coil conductor 3B when viewed from the positive side to the negative side in the X-axis direction.

The side surface 2Be (surface on one side) of the magnetic body 2B on the positive side in the Z-axis direction is located on the negative side in the Z-axis direction with respect to the coupling portions 13A and 13B. As a result, in the regions 17A and 17B, a gap ST (see FIG. 4) is formed between the side surface 2Be of the magnetic body 2B and the lower surfaces 13Aa and 13Ba of the coupling portions 13A and 13B. The side surfaces 2Ae and 2Ce of the magnetic bodies 2A and 2C on the positive side in the Z-axis direction are located on the positive side in the Z-axis direction with respect to the lower surfaces 13Aa and 13Ba (the other surfaces) of the coupling portions 13A and 13B (see FIG. 3). However, the side surfaces 2Ae and 2Ce of the magnetic bodies 2A and 2C on the positive side in the Z-axis direction may have the same position in the Z-axis direction as the lower surfaces 13Aa and 13Ba of the coupling portions 13A and 13B. The end surfaces 2Bc and 2Bd of the magnetic body 2B on both sides of the Y-axis direction are disposed outside the conductor portions 11A, 12A, 11B, and 12B in the Y-axis direction (see FIG. 4). The same applies to the magnetic bodies 2A and 2C.

In the present embodiment, the side surfaces 2Af and 2Cf (surfaces on the other side) of the magnetic bodies 2A and 2C on the negative sides in the Z-axis direction are placed on the upper surfaces 14a and 16a of the terminal portions 14A, 16A, 14B, and 16B. In the present embodiment, the side surface 2Bf of the magnetic body 2B on the negative side in the Z-axis direction is disposed at the same height as the lower surfaces 14b and 16b of the terminal portions 14A, 16A, 14B, and 16B. Note that the “same height” includes an error within a range caused by a manufacturing variation.

The magnetic bodies 2A, 2B, and 2C are longer than the conductor portions 11A, 11B, 12A, and 12B in the Z-axis direction. The lengths of the conductor portions 11A, 11B, 12A, and 12B in the Z-axis direction are dimensions in the Z-axis direction between the lower surfaces 13Aa and 13Ba of the coupling portions 13A and 13B and the upper surfaces 14a and 16a of the terminal portions 14A, 14B, 16A, and 16B.

Next, the resin material 5 will be described. The resin material 5 covers the entire assembly including the magnetic bodies 2A, 2B, and 2C and the coil conductors 3A and 3B. The resin material 5 exposes at least the lower surfaces of the terminal portions 14A, 16A, 14B, and 16B. Therefore, the resin material 5 covers at least the side surfaces 2Ae, 2Be, and 2Ce of the magnetic bodies 2A, 2B, and 2C on the positive side in the Z-axis direction. The resin material 5 contains magnetic powder. Specifically, a thermosetting resin such as epoxy is adopted as a material of the resin material 5. In a case where the resin material 5 contains a magnetic powder, a mixture of a soft magnetic metal powder and a resin or the like may be adopted. As the soft magnetic metal powder, an iron-silicon alloy, permalloy, sendust, amorphous, nanocrystalline alloy, or a mixture thereof may be used. In a case where the resin material 5 contains magnetic powder, the magnetic permeability of the resin material 5 may be 5 or more, or 20 or more. The magnetic permeability of the resin material 5 may be 100 or less, and may be 50 or less. The resin material 5 may have a magnetic permeability lower than that of the magnetic bodies 2A, 2B, and 2C. As illustrated in FIG. 4, the resin material 5 is disposed in the regions 17A and 17B. That is, the resin material 5 is formed to cover the surfaces 11Aa, 11Ba, 12Aa, 12Ba, 13Aa, and 13Ba. In the resin material 5, a portion covering the magnetic bodies 2A, 2B, and 2C and the coil conductors 3A and 3B from the outer peripheral side will be referred to as a first resin portion 20A, and a portion disposed in the regions 17A and 17B will be referred to as a second resin portion 20B.

The resin material 5 is formed by performing mold resin molding on an assembly of the magnetic bodies 2A, 2B, and 2C and the coil conductors 3A and 3B. The first resin portion 20A and the second resin portion 20 of the resin material 5 are coupled to each other via the gap ST in the regions 17A and 17B.

Next, functions and effects of the inductor 1 and the DC-DC converter 100 according to the present embodiment will be described.

In the conventional inductor, there is a problem that a resin material hardly wraps around a space on an inner peripheral side of a coil conductor, and the adhesion between a component and the resin material is reduced. There is a problem that a variation in inductance increases as a variation in dimension of a low-permeability portion increases.

In contrast, in the inductor 1 according to the present embodiment, the magnetic body 2A covers the region 17A surrounded by the conductor portions 11A and 12A, the coupling portion 13A, and the virtual line VL connecting the ends of the conductor portions 11A and 12A on the negative side in the Z-axis direction when viewed from the X-axis direction. The magnetic body 2C covers the region 17B surrounded by the conductor portions 11B and 12B, the coupling portion 13B, and the virtual line VL connecting the ends of the conductor portions 11B and 12B on the negative side in the Z-axis direction when viewed from the X-axis direction. Here, the resin material 5 covers at least the surfaces of the magnetic bodies 2A, 2B, and 2C on the positive side in the Z-axis direction. The resin material is disposed in the regions 17A and 17B. Therefore, at the time of molding, the resin material 5 flows around the magnetic bodies 2A, 2B, and 2C and the coil conductors 3A and 3B, and flows into the regions 17A and 17B. In this case, since a mold resin MD of the resin material 5 is covered with the magnetic body 2A from the positive side in the X-axis direction of the coil conductor 3A, the mold resin MD does not enter the inside of the region 17A. The mold resin MD of the resin material 5 is covered with the magnetic body 2C from the negative side in the X-axis direction of the coil conductor 3B and thus does not enter the inside of the region 17B. On the other hand, the surface (side surface 2Be) of magnetic body 2B on the positive side in the Z-axis direction is located on the negative side in the Z-axis direction with respect to the coupling portions 13A and 13B. Thus, the gap ST is formed on the negative side in the X-axis direction of the region 17A and the positive side in the X-axis direction of the region 17B. The mold resin MD can smoothly flow into the regions 17A and 17B from the gap ST. Thus, the adhesion between other components and the resin material 5 is improved, the stability of a positional relationship between members is enhanced, the members are less likely to be separated, a variation in inductance is small, and a highly reliable inductor can be obtained.

The surfaces (side surfaces 2Ae and 2Ce) of the magnetic bodies 2A and 2C on the positive side in the Z-axis direction may be located on the positive side in the Z-axis direction with respect to the surfaces (lower surfaces 13Aa and 13Ba) of the coupling portions 13A and 13B on the negative side in the Z-axis direction. In a case where the heights in the Z-axis direction of not only the central magnetic body 2B but also the magnetic bodies 2A and 2C on both sides are lowered, and the side surfaces 2Ae and 2Ce are disposed on the negative side in the Z-axis direction with respect to the coupling portions 13A and 13B, the thicknesses of the entire magnetic bodies 2A, 2B, and 2C in the Z-axis direction is reduced, and the inductance decreases. In contrast, in the present embodiment, by shifting only the central magnetic body 2B to the position on the negative side in the Z-axis direction, the thickness of the entire magnetic body can be secured, and the inductance can be improved. By shifting the Z component of the magnetic flux of the coil conductors 3A and 3B downward, the leakage magnetic flux from the upper surface of the inductor 1 can be reduced.

The magnetic bodies 2A, 2B, and 2C may have the same area when viewed from the X-axis direction. In this case, the magnetic flux passing through the magnetic bodies 2A, 2B, and 2C can be evenly distributed.

The magnetic bodies 2A, 2B, and 2C may have the same size. In this case, the magnetic flux passing through the magnetic bodies 2A, 2B, and 2C can be evenly distributed. Since the magnetic flux is uniformly distributed, local magnetic saturation hardly occurs, and the DC superposition characteristics of inductance are improved.

The magnetic bodies 2A, 2B, and 2C may be longer than the conductor portions 11A, 11B, 12A, and 12B in the Z-axis direction. In this case, the inductance can be improved by securing the sizes of the magnetic bodies 2A, 2B, and 2C in the Z-axis direction.

The coil conductor 3A includes the terminal portions 14A and 16A respectively connected to the ends of the conductor portions 11A and 12A on the negative side in the Z-axis direction. The coil conductor 3B includes the terminal portions 14B and 16B respectively connected to the ends of the conductor portions 11B and 12B on the negative side in the Z-axis direction. In this case, the mounting reliability of the inductor 1 on the substrate 101 can be improved by the terminal portions 14A, 16A, 14B, and 16B.

The surface of the magnetic body 2B on the negative side in the Z-axis direction may be disposed in the same plane as the surfaces of the terminal portions 14A, 14B, 16A, and 16B on the negative side in the Z-axis direction. In this case, since the central magnetic body 2B can be supported at the same position as the surfaces, on the negative side in the Z-axis direction, of the terminal portions 14A, 14B, 16A, and 16B which are lower surfaces in the assembly, the magnetic body 2B can be brought into contact with a molding die when the resin material 5 is molded. Since the Z-axis direction of the magnetic body 2B is restricted by a die surface, the position stability of the magnetic body 2B can be improved, and the adhesion to the resin material 5 can be improved.

The resin material may contain magnetic powder. In this case, the inductance of the inductor 1 can be improved.

The terminal portions 14A and 16A respectively extend in the X-axis direction from the ends of the conductor portions 11A and 12A on the negative side in the Z-axis direction, and the terminal portions 14B and 16B respectively extend in the X-axis direction from the ends of the conductor portions 11B and 12B on the negative side in the Z-axis direction. Consequently, the mounting reliability of the inductor 1 on the substrate 101 can be improved.

The magnetic body 2A may be placed on the terminal portions 14A and 16A, and the magnetic body 2C may be placed on the terminal portions 14B and 16B. In this case, the magnetic bodies 2A and 2C are sufficiently supported at the time of molding the resin material 5, so that the position stability can be improved. Thus, a characteristic difference between the two coil conductors 3A and 3B can be reduced.

The DC-DC converter 100 according to the present embodiment includes the inductor described above.

According to the DC-DC converter 100, since a variation in the inductance of the inductor 1 is small, it is possible to obtain the DC-DC converter 100 in which a variation in an output waveform is small. Since the adhesion between the resin and the magnetic bodies is high, the DC-DC converter 100 having high long-term reliability can be obtained.

The present disclosure is not limited to the above-described embodiments.

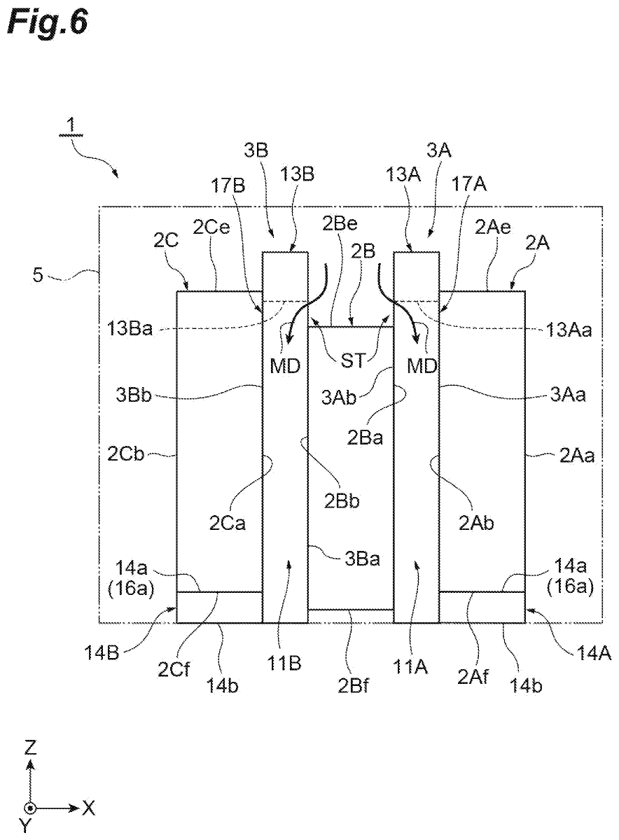

For example, the central magnetic body 2B has the same size as the magnetic bodies 2A and 2B on both sides, but need not have the same size. The side surface 2Bf of the magnetic body 2B on the negative side in the Z-axis direction needs not be on the same plane as the surface of the terminal portions 14A, 14B, 16A, and 16B on the negative side in the Z-axis direction. For example, the structure illustrated in FIG. 6 may be adopted. In the structure illustrated in FIG. 6, the magnetic body 2B is smaller than the magnetic bodies 2A, 2C in the Z-axis direction. The side surface 2Bf of the magnetic body 2B on the negative side in the Z-axis direction is not disposed on the same plane as the surfaces of the terminal portions 14A, 14B, 16A, and 16B on the negative side in the Z-axis direction.

### [Aspect 1]

An inductor including:
a first coil conductor including first and second conductor portions that extend in a first direction, and a first coupling portion that couples ends of the first and second conductor portions on one side in the first direction to each other and extends in a second direction orthogonal to the first direction;
a second coil conductor including third and fourth conductor portions that extend in the first direction, and a second coupling portion that couples ends of the third and fourth conductor portions on the one side in the first direction and extends in the second direction;
a first magnetic body disposed between the first coil conductor and the second coil conductor, the first coil conductor and the second coil conductor being disposed apart from each other in a third direction orthogonal to the first direction and the second direction;
a second magnetic body disposed to sandwich a portion located between the first and second conductor portions with the first magnetic body in the third direction;
a third magnetic body disposed to sandwich a portion located between the third and fourth conductor portions with the first magnetic body in the third direction; and
a resin material covering at least surfaces of the first, second, and third magnetic bodies on the one side in the first direction, in which
the second magnetic body covers a first region surrounded by the first and second conductor portions, the first coupling portion, and a virtual line connecting the ends of the first and second conductor portions on the other side in the first direction when viewed from the third direction,
the third magnetic body covers a second region surrounded by the third and fourth conductor portions, the second coupling portion, and a virtual line connecting the ends of the third and fourth conductor portions on the other side in the first direction when viewed from the third direction,
a surface of the first magnetic body on the one side in the first direction is located on the other side in the first direction with respect to the first and second coupling portions, and
the resin material is disposed in the first and second regions.

### [Aspect 2]

The inductor according to Aspect 1, in which surfaces of the second and third magnetic bodies on the one side in the first direction are located on the one side in the first direction with respect to surfaces of the first and second coupling portions on the other side in the first direction.

### [Aspect 3]

The inductor according to Aspect 1 or 2, in which the first, second, and third magnetic bodies have the same area when viewed from the third direction.

### [Aspect 4]

The inductor according to Aspect 3, wherein the first, second, and third magnetic bodies have the same size.

### [Aspect 5]

The inductor according to any one of Aspects 1 to 4, in which the first, second, and third magnetic bodies are longer than the first, second, third, and fourth conductor portions in the first direction.

### [Aspect 6]

The inductor according to any one of Aspects 1 to 5, in which
the first coil conductor includes first and second terminal portions respectively connected to the ends of the first and second conductor portions on the other side in the first direction, and
the second coil conductor includes third and fourth terminal portions respectively connected to the ends of the third and fourth conductor portions on the other side in the first direction.

### [Aspect 7]

The inductor according to Aspect 6, in which a surface of the first magnetic body on the other side in the first direction is disposed on the same plane as surfaces of the first, second, third, and fourth terminal portions on the other side in the first direction.

### [Aspect 8]

The inductor according to any one of Aspects 1 to 7, in which the resin material contains magnetic powder.

### [Aspect 9]

The inductor according to Aspect 6, in which
the first and second terminal portions respectively extend in the third direction from the ends of the first and second conductor portions on the other side in the first direction, and
the third and fourth terminal portions respectively extend in the third direction from the ends of the third and fourth conductor portions on the other side in the first direction.

### [Aspect 10]

The inductor according to Aspect 9, in which
the second magnetic body is placed on the first and second terminal portions, and
the third magnetic body is placed on the third and fourth terminal portions.

### [Aspect 11]

A DC-DC converter including the inductor of any one of Aspects 1 to 10.

### REFERENCE SIGNS LIST

1 Inductor
2A Magnetic body (second magnetic body)
2B Magnetic body (first magnetic body)
2C Magnetic body (third magnetic body)
3A Coil conductor (first coil conductor)
3B Coil conductor (second coil conductor)
5 Resin material
11A Conductor portion (first conductor portion)
11B Conductor portion (third conductor portion)
12A Conductor portion (second conductor portion)
12B Conductor portion (fourth conductor portion)
13A Coupling portion (first coupling portion)
13B Coupling portion (second coupling portion)
14A Terminal portion (first terminal portion)
14B Terminal portion (third terminal portion)
16A Terminal portion (second terminal portion)
16B Terminal portion (fourth terminal portion)
17A Region (first region)
17B Region (second region)
100 DC-DC converter.

What is claimed is:

1. An inductor comprising:
a first coil conductor including first and second conductor portions that extend in a first direction, and a first coupling portion that couples ends of the first and second conductor portions on one side in the first direction to each other and extends in a second direction orthogonal to the first direction;
a second coil conductor including third and fourth conductor portions that extend in the first direction, and a second coupling portion that couples ends of the third and fourth conductor portions on the one side in the first direction and extends in the second direction;
a first magnetic body disposed between the first coil conductor and the second coil conductor, the first coil conductor and the second coil conductor being disposed apart from each other in a third direction orthogonal to the first direction and the second direction;
a second magnetic body disposed to sandwich a portion located between the first and second conductor portions with the first magnetic body in the third direction;
a third magnetic body disposed to sandwich a portion located between the third and fourth conductor portions with the first magnetic body in the third direction; and
a resin material covering at least surfaces of the first, second, and third magnetic bodies on the one side in the first direction, wherein
the second magnetic body covers a first region surrounded by the first and second conductor portions, the first coupling portion, and a virtual line connecting the ends of the first and second conductor portions on the other side in the first direction when viewed from the third direction,
the third magnetic body covers a second region surrounded by the third and fourth conductor portions, the second coupling portion, and a virtual line connecting the ends of the third and fourth conductor portions on the other side in the first direction when viewed from the third direction,
a surface of the first magnetic body on the one side in the first direction is located on the other side in the first direction with respect to the first and second coupling portions, and
the resin material is disposed in the first and second regions.

2. The inductor according to claim 1, wherein surfaces of the second and third magnetic bodies on the one side in the first direction are located on the one side in the first direction with respect to surfaces of the first and second coupling portions on the other side in the first direction.

3. The inductor according to claim 1, wherein the first, second, and third magnetic bodies have the same area when viewed from the third direction.

4. The inductor according to claim 3, wherein the first, second, and third magnetic bodies have the same size.

5. The inductor according to claim 1, wherein the first, second, and third magnetic bodies are longer than the first, second, third, and fourth conductor portions in the first direction.

6. The inductor according to claim 1, wherein
the first coil conductor includes first and second terminal portions respectively connected to the ends of the first and second conductor portions on the other side in the first direction, and
the second coil conductor includes third and fourth terminal portions respectively connected to the ends of the third and fourth conductor portions on the other side in the first direction.

7. The inductor according to claim 6, wherein a surface of the first magnetic body on the other side in the first direction is disposed on the same plane as surfaces of the first, second, third, and fourth terminal portions on the other side in the first direction.

8. The inductor according to claim 1, wherein the resin material contains magnetic powder.

9. The inductor according to claim 6, wherein
the first and second terminal portions respectively extend in the third direction from the ends of the first and second conductor portions on the other side in the first direction, and
the third and fourth terminal portions respectively extend in the third direction from the ends of the third and fourth conductor portions on the other side in the first direction.

10. The inductor according to claim 9, wherein
the second magnetic body is placed on the first and second terminal portions, and
the third magnetic body is placed on the third and fourth terminal portions.

11. A DC-DC converter comprising the inductor according to claim 1.
